(19) United States
(12) Patent Application Publication
(10) Pub. No.: US 2009/0164374 A1
(43) Pub. Date: Jun. 25, 2009

(54) System and Methods for One Time Check Numbers

(75) Inventor: Vishwanath Shastry, Mountain View, CA (US)

Correspondence Address: RACUNAS LAW LLC, C/O INTELLEVATE, P.O. BOX 52050, MINNEAPOLIS, MN, 55402, US

(73) Assignee: EBAY INC., San Jose, CA (US)

(21) Appl. No.: 11/963,606

(22) Filed: Dec. 21, 2007

(51) Int. Cl. G06Q 20/00; G06Q 40/00

(52) U.S. Cl. 705/44; 705/45

(57) ABSTRACT

Various embodiments are directed to third-party payment services including the ability to arrange and pay for goods or services with a printed paper check using facilities hosted by the third-party payment service. In one embodiment, a third-party payment services system may be arranged to provide access to a third-party payment account linked to a source of funds for the third-party payment account. The third-party payment services system may receive a request to transfer funds from the third-party payment account to a recipient using a printed check and may receive a use limitation for the check. A unique number to be printed on the check may be derived and associated with the third-party payment account. A payment request for the check may be verified using the unique number when use limitations for the check have been observed. Other embodiments are described and claimed.

### TECHNICAL FIELD

Various embodiments relate generally to providing third-party payment services and, more specifically but not exclusively relate to a system and methods to provide users of a third-party payment service with the ability to arrange and pay for goods or services with a printed check using facilities hosted by the third-party payment service.

### BACKGROUND

Online purchases of products and services may be made using a third-party payment service, such as PayPal®, Mountain View, Calif. In such cases, payment may be made electronically by credit card or by debiting the payment services account of the sender (buyer) and then crediting the payment services account of the recipient (seller). Ultimately, the received funds may be directed to a personal bank account of the seller listed with the third-party payment service.

Third-party payment services facilitate various types of individual person-to-person transactions where neither the seller nor the buyer is a merchant. A common form of this type of transaction is an online auction, such as auctions hosted by eBay® Corporation, San Jose, Calif. Third-party online auction hosts, such as eBay®, provide a web-based platform that enables sellers to list and display items for sale, and buyers to bid on the items that are offered. Often, the seller of an auctioned item is an individual that can only accept electronic or credit card payments for the item by using the third-party payment service.

In many situations, however, the preferred form of payment instrument for an individual is a personal check. For example, an individual seller may not be capable of or may not accept electronic payments for a variety of reasons and therefore may require a personal check. Or, an individual simply may prefer to make payments using checks for goods such as groceries and personal items, services such as monthly rent and cleaning services, and bills such as telephone bills, utility bills, and credit card bills.

Conventional paper instruments, such as checks written from a personal checking account, are subject to theft and fraudulent use especially when payment is made to an individual. For example, a fraudster may obtain the routing and account numbers from a check and use the information to illegally withdraw funds from the personal checking account by generating fake checks, conducting an electronic check or Automated Clearing House (ACH) transaction, or using the routing and account numbers with a third-party payment service.

### SUMMARY

Various embodiments are directed to third-party payment services providing the ability to arrange and pay for goods or services with a printed check using facilities hosted by the third-party payment service. In one embodiment, a third-party payment services system may be arranged to provide access to a third-party payment account linked to a source of funds for the third-party payment account. The third-party payment services system may receive a request to transfer funds from the third-party payment account to a recipient using a printed check and may receive a use limitation for the check. A unique number to be printed on the check may be derived and associated with the third-party payment account. A payment request for the check may be verified using the unique number when use limitations for the check have been observed. Other embodiments are described and claimed.

### BRIEF DESCRIPTION OF THE DRAWINGS

The foregoing aspects and many of the attendant advantages of various embodiments will become more readily appreciated and better understood by reference to the following detailed description and the accompanying drawings.

FIG. 1 is a schematic diagram illustrating an exemplary communications system for providing third-party payment services in accordance with various embodiments.

FIG. 2 illustrates is a representation of a web page hosted by the third-party payment services system for providing third-party payment services in accordance with various embodiments.

FIG. 3 is a flowchart illustrating operations and logic performed by software components operated by the third-party payment services system to provide third-party payment services in accordance with various embodiments.

### DETAILED DESCRIPTION

Various embodiments are described for providing users of a third-party payment service with the ability to arrange and pay for goods or services with a printed check using facilities hosted by the third-party payment service. Numerous specific details are set forth to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

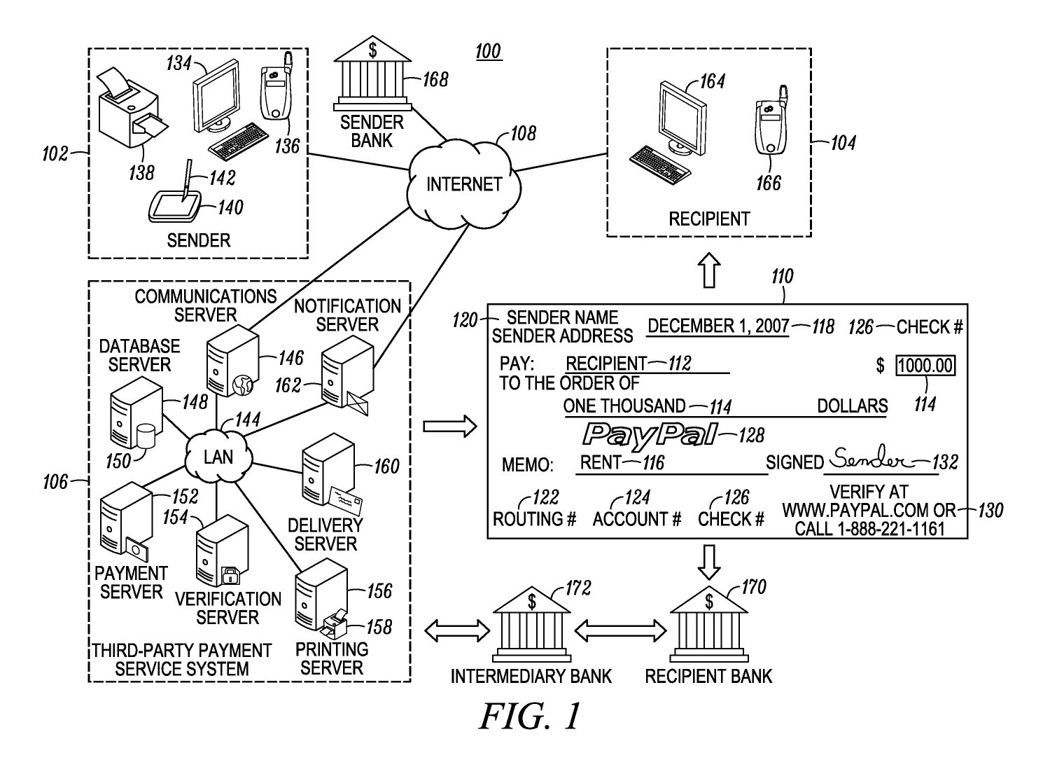

FIG. 1 illustrates a communications system 100 suitable for implementing various embodiments. Elements of the communications system 100 may comprise physical or logical entities for communicating information and, in some cases, may be implemented as hardware, software, firmware, or combination thereof, as desired for a given set of design parameters or performance constraints. Although FIG. 1 includes a limited number of elements for purposes of illustration, it can be appreciated that the communications system 100 may include more or less elements as well as other types of elements.

The communications system 100 may comprise a sender 102 arranged to initiate a transfer of funds, such as one or more payments for products and/or services, to a recipient 104 using a third-party payment service 106. In various embodiments, the sender 102 may be capable of wired and/or wireless communication and may access the third-party payment services system 106 over one or more types of networks including the Internet 108. In wireless implementations, for example, the sender 102 may access the third-party payment service system 106 over the Internet 108 via a wireless local area network (WLAN) or cellular telephone network supporting wireless wide area network (WWAN) functionality.

Generally, each of the sender 102 and recipient 104 may be associated with one or more individuals or entities in accordance with the described embodiments. In some cases, the transfer of funds from the sender 102 to the recipient 104 may initiate, be part of, or complete an individual person-to-person transaction. For example, the sender 102 may be associated with a buyer of a good or service, and the recipient 104 may be the seller of a good or service.

In various embodiments, the third party payment service system 106 may provide the sender 102 with the ability to transfer funds to the recipient 104 using a printed paper check 110 or any other financial instrument in accordance with the described embodiments. In the context of payments made using the check 110, the sender 102 may be associated with the payor or the paying party, and the recipient 104 may be associated with the payee or the party to be paid. While some embodiments may be described in the context of payments from buyers to sellers, it can be appreciated that various aspects of the system and methods described herein may be implemented for a variety of financial transactions involving transfers of funds between individuals, transfers of funds between business entities, bill payments, gifts, refunds, and other types of transactions involving an exchange of value.

In order to use the third-party payment service system 106 to transfer funds to the recipient 104 with the check 110, the sender 102 generally either must have or establish a third-party payment account with the third-party payment service system 106. To open a third-party payment account, the sender 102 may navigate to a registration web page associated with the third-party payment service system 106 and enter required authentication information including a unique user identifier, a password, and contact information.

The third-party payment account may be linked to a source of funds for the third-party payment account and the check 110. The sender 102 may enter information for one or more entities or accounts which can be drawn on to credit the third-party payment account of the sender 102. It can be appreciated that the sender 102 may provide any type of entity or account capable of supplying funds to the third-party payment account in accordance with the described embodiments. Exemplary entities and/or accounts may include, without limitation, a bank, bank account, lender, line-of-credit, credit card company, credit card account, debit card, prepaid debit card account, payroll account, check, money order, or any other suitable supply of financial value. Once such information has been entered, the sender 102 may authorize funds to be drawn on such entities and/or accounts. In various embodiments, multiple entities and/or accounts associated with the sender 102 may be listed in an electronic wallet enabling the sender 102 to select among such entities and accounts for different payment transactions.

To initiate a transfer of funds to the recipient 104 using the check 110, the sender 102 may navigate to a payment web page associated with the third-party payment service system 106 and enter details for the check 110. The check details may comprise, for example, date, the name of the recipient 104 or payee, the address of the recipient 104, and the value amount and currency. In general, the date of the check 110 may be automatically generated but may be edited by the sender 102 to specify a future date, for instance. In some implementations, the name of the recipient 104 may be entered by the sender 102 or selected from a pull-down menu of contacts associated with the sender 102. When selected from the pull-down menu, the address of the recipient 104 as well as other check details may be populated automatically. In some cases, various check details may be populated automatically based on previous transaction history when a certain recipient 104 is entered or selected.

It can be appreciated that while some embodiments may be described in the context of a transfer of funds initiated via a web page hosted by the third-party payment services system 106, the embodiments are not limited in this regard. For example, in some implementations, the transfer of funds or other financial transaction may be initiated by the sender 102 using authenticated/encrypted e-mail, via a cellular or wireless device, and/or other modalities in accordance with the described embodiments.

The check details also may comprise a notation or other identifying information associated with the purpose of the check 110. In some implementations, the sender 102 may select from among predefined categories such as goods or services and/or may enter a memo noting the purpose of the check 110. The check details also may comprise the source of the funds for the check 110. For example, a source of funds may be selected by the sender 102 from a pull-down menu of entities and/or accounts associated with the electronic wallet of the sender 102.

The check details may comprise one or more options for coordinating the delivery of the check 110 to the recipient. In some cases, the sender 102 may select from among predefined options by which the check 110 may be printed and delivered to the recipient 104 using services provided by the third-party payment service system 106. In various implementations, the third-party payment service system 106 may provide the sender 102 with the option of either assuming or assigning the responsibility of printing out and delivering the check 110 to the recipient 104. When the sender 102 assigns the responsibility of the printing and delivering the check 110 to the third-party payment service system, the sender 102 also may specify delivery options such as first class mail, priority mail, or overnight delivery.

The check details also may comprise limitations on the use of the check 110. In various implementations, the third-party payment service system 106 may provide the sender 102 with the option of designating the check 110 for one time use or designating various other limitations on the use of the check 110. When designated for one time use, the check 110 may include information such as a unique number that is capable of being verified only once, only for the specific transfer of funds from the sender 102 to the recipient 104, and only for the fixed amount of the transfer. In such cases, if a fraudster received check 110, the fraudster could only attempt to obtain the specific value of the check 110 by posing as the recipient 104. The fraudster, however, would not be able to use the information from the check 110 for any other withdrawals from the third-party account and/or any other entity or account of the sender 102 which serves as the source of funds for the check 110 and is linked to the third-party payment account.

In various embodiments, the sender 102 may be capable of limiting the use of the check 110 in a various ways in addition to or other than for one time use. In some implementations, for example, the sender 102 may indicate that the check 110 may include information which may be used multiple times but only for the recipient 104. In such cases, the check 110 may include information such as a unique number that is capable of being used by the recipient 104 for multiple withdrawals, such as for recurring automatic payments, but that can be verified only for transfers of funds from the sender 102 to the recipient 104.

In some implementations, the sender 102 may indicate the number of times that the information from the check 110 may be reused. For example, the sender 102 may allow the information from the check 110 to be reused but only for a certain number of transactions. In such cases, the information from the check 110 may include a unique number that is capable of being verified but only when the number of transactions is equal to or below the maximum number of transactions set by the sender 102.

In some implementations, the sender 102 may limit the use of the check 110 to an exact value, a maximum value, and/or range of values. For example, the sender 102 may allow the information from the check 110 to be reused but only for recurring transactions in which the amount of the transfer is known or predictable. The amounts of certain recurring payments or bills may be known or predictable by the sender 102, for instance. In such cases, the information from the check 110 may include a unique number that is capable of being verified only for a transfer of funds for the exact value, equal to or below the maximum value, and/or falling within the range of values set by the sender 102.

In some implementations, the sender 102 may limit the use of the check 110 to a specific date, a latest date, and/or date range. For example, the sender 102 may allow the information from the check 110 to be reused but only for recurring transactions in which the timing of the transfer is known or predictable. The timing or due dates for certain recurring payments or bills may be known or predictable by the sender 102, for instance. In this case, the information from the check 110 may include a unique number that is capable of being verified but only for a transfer of funds occurring on a specific date, on or before the latest date, and/or within the date range set by the sender 102.

After receiving the check details and the limitations for the check 110 from the sender 102, the third-party payment service system 106 may be arranged to derive a unique number for the check 110 for implementing the transfer of funds from the sender 102 to the recipient 104. In the ideal case for one time use numbers, a unique number would be derived for each and every transaction in perpetuity. However, to avoid running out of unique numbers having a certain maximum length, a time widow may be established to allow unique numbers to be reused. For example, unique numbers may be reused, but only after a certain significant time period (e.g., 2 years) has elapsed such that the probability that a unique number will be used to access the same account is nearly zero. In some cases, the generation of unique numbers may be completely random for maximum security. In other cases, however, certain ranges of unique numbers may be used based on certain check details to facilitate back-end processing and/or tracking while still preserving the integrity of the unique numbers.

Once the unique number for the check 110 has been derived, the third-party payment service system 106 may associate or map the unique number to the third-party payment account of the sender 102. When associated with the third-party payment account of the sender 102, the unique number may be used by the third-party payment service system 106 to differentiate among transaction and users, identify the third-party account of the sender 102, access various details of the check 110, verify the check 110, and/or identify and withdraw funds from entity or account of the sender 102 that serves as the source of funds for the check 110 and is linked to the third-party payment account. It can be appreciated that while the unique number may reference the third-party payment account of the sender 102, there is no direct relationship or correlation between the unique number and the entity or account (e.g., bank account, credit card account, etc.) of the sender 102 which is used to fund the third-party payment account and the check 110.

After the unique number is derived and associated with the third-party payment account of the sender 102, the check 110 may be printed. In some implementations, the check 110 may be printed using the local printing capabilities of the sender 102. In other implementations, the check 110 may be printed using the printing capabilities of the third-party payment services system 106. It can be appreciated that the third-party payment services system 106 may comprise or implement integrated printing capabilities and/or may send print requests for fulfillment by a printing facility external to the third-party payment service system 106.

In various embodiments, the check 110 may be printed to include the unique number derived by the third-party payment service system 106 as well as various check details which were entered by the sender 102 and/or are automatically populated by the third-party payment service system 106. As shown in the embodiment of FIG. 1, the check 110 may comprise a payee name 112 (e.g., Recipient), a check value 114 represented in words (e.g., ONE THOUSAND) and numbers (1000.00), and a memo 116 (e.g., RENT) in accordance with the check details provide by the sender 102.

The check 110 also may comprise details which may be automatically populated including a date 118 (e.g., Dec. 1, 2007), the name and address of the payor 120 (e.g., Sender), a routing number 122 appearing at the bottom of the check 110, an account number 124 appearing at the bottom of the check 110, a check number 126 appearing at the bottom and top of the check 110, a paying entity name 128 (e.g., PayPal) identifying the third-party payment services system 106 and corresponding to the routing number 122, and contact information 130 for the paying entity such as a web site (e.g., www.paypal.com) and a telephone number (e.g., 1-888-221-1161) which may be used for obtaining check details and/or verification.

In general, the routing number 122 of the check 110 may be associated with and used to identify an entity capable of handling a payment request and/or verification of the check 110. In some embodiments, the routing number 122 of the check 110 may be associated with the third-party payment services system 106. In such cases, the paying entity name 128 will correspond to the routing number 122 and likewise identify the third-party payment services system 106. The contact information 130 also will direct inquiries regarding check details and/or verification to the third-party payment services system 106.

In some embodiments, the routing number 122 may be associated with an entity such as a bank or other financial institution having a contractual relationship with the third-party payment services system 106. In such cases, the paying entity name 128 will correspond to the routing number 122 and identify the entity having the contractual relationship with the third-party payment services system 106. The contact information 130 also will direct inquiries regarding check details and/or verification to the financial entity having the contractual relationship with the third-party payment services system 106.

As shown, the check 110 may comprise a signature 132 of the sender 102. In cases where the sender 102 locally prints the check 110, the check 110 may be printed unsigned, and the signature 132 may represent the actual signing by the sender 102. In cases where the third-party payment services system 106 prints the check 110, the signature 132 may be provided contemporaneously by the sender 102 using an electronic signature pad and digitizing pen, for example, or may be populated by the third-party payment services system 106 using a signature provided previously by the sender 102 and stored in the third-party payment account of the sender 102. It can be appreciated that the signature 132 may be provided using any suitable technique that allows the check 110 to be properly presented and settled.

It can be appreciated that not all implementations may require the signature 132 of the sender 102. For example, in some implementations, the payor of the check 110 may be the third-party payment services system 106. In such cases, the check 110 may include appropriate identifying information to inform the recipient 104 that the check 110 is payment on behalf of the sender 102, thus alleviating the need to capture the signature of the sender 102.

The unique number may be printed on the check 110 and implemented in various ways in accordance with the described embodiments. In some implementations, the unique number may be printed as the account number 124. When the account number 124 comprises the unique number, the account number 124 may be used by the third-party payment services system 106 to differentiate among transaction and users, identify the third-party account of the sender 102, access various details of the check 110, verify the check 110, and/or identify and withdraw funds from an entity or account of the sender 102 that serves as the source of funds for the check 110 and is linked to the third-party payment account. It can be appreciated that while the account number 124 may reference the third-party payment account of the sender 102, there is no direct relationship or correlation between the account number 124 and the entity or account of the sender 102 which is used to fund the third-party payment account and the check 110.

In some embodiments, the account number 124 may comprise the unique number, and the routing number 122 may be associated with the third-party payment services system 106. In such cases, the routing number 122 may be used to identify and direct payment requests and/or inquiries regarding check details and/or verification based on the unique number (e.g., account number 124) to the third-party payment services system 106.

In some embodiments, the account number 124 may comprise the unique number, and the routing number 122 may be associated with an entity such as a bank or other financial institution having a contractual relationship with the third-party payment services system 106. In such cases, the routing number 122 may be used to identify and direct payment requests and/or inquiries regarding check details and/or verification based on the unique number (e.g., account number 124) to the financial entity having a contractual relationship with the third-party payment services system 106.

In some implementations, the unique number may be printed as the check number 126. When the check number 126 comprises the unique number, the account number 124 on the check 110 may be associated with a single master account at the third-party payment service system 106, and the check number 126 may be used by the third-party payment services system 106 to differentiate among transaction and users, identify the third-party account of the sender 102, access various details of the check 110, verify the check 110, and/or identify and withdraw funds from an entity or account of the sender 102 that serves as the source of funds for the check 110 and is linked to the third-party payment account. It can be appreciated that while the check number 126 may reference the third-party payment account of the sender 102, there is no direct relationship or correlation between the check number 126 and the entity or account of the sender 102 which is used to fund the third-party payment account and the check 110.

In some embodiments, the check number 126 may comprise the unique number and the routing number 122 may be associated with the third-party payment services system 106. In such cases, the routing number 122 may be used to identify and direct payment requests and/or inquiries regarding check details and/or verification based on the unique number (e.g., check number 126) to the third-party payment services system 106.

In some embodiments, the check number 126 may comprise the unique number and the routing number 122 may be associated with an entity such as a bank or other financial institution having a contractual relationship with the third-party payment services system 106. In such cases, the routing number 122 may be used to identify and direct payment requests and/or inquiries regarding check details and/or verification based on the unique number (e.g., check number 126) to the financial entity having a contractual relationship with the third-party payment services system 106.

After being printed, the check 110 may be delivered to the recipient 104. In some implementations, the check 110 may be printed using the local printing capabilities of the sender 102, signed, and then mailed or hand delivered to the recipient 104. In other implementations, the check 110 may be printed using the printing capabilities of the third-party payment services system 106. It can be appreciated that the third-party payment services system 106 may comprise or implement integrated delivery capabilities for coordinating deliveries and/or may employ facilities external to the third-party payment service system 106.

In various implementations, the third-party payment service system 106 also may be arranged to confirm details of the check based on the unique number in response to a verification request from the recipient 104 or another entity (e.g., financial institution) seeking to confirm the authenticity of the check. For example, upon receipt of the check 110, the recipient 104 or entity may communicate with the third-party payment service system 106 by telephone or over the Internet 108 according to the contact information 130. The recipient 104 or entity may provide the unique number in response to voice prompts or in a data field in a web page and, in response, receive check details and/or verification of the check 110.

After the check 110 is delivered to the recipient 104, a payment request for the check 110 is issued. For example, when the recipient 104 deposits the check 110, the routing number 122 may be used to identify an entity capable of handling a payment request and/or verification of the check 110. In some embodiments, the routing number 122 of the check 110 may be associated with the third-party payment services system 106. In such cases, the check 110 along with a payment request may be presented to the third-party payment services system 106 based on the routing number 122.

In some embodiments, the routing number 122 may be associated with an entity such as a bank or other financial institution having a contractual relationship with the third-party payment services system 106. In such cases, the check 110 along with a payment request may be presented to the financial entity having the contractual relationship with the third-party payment services system 106 based on the routing number 122. The entity may then forward the check 110 along with the payment request to the third-party payment services system 106 for verification and settlement.

Upon receiving a payment request for the check 110, the third-party payment services system 106 may verify the check 110 using the unique number printed on the check 110. In various embodiments, the third-party payment service system 106 may use the unique number to identify the third-party payment account of the sender 102 and access various details of the check 110. For example, the third-party payment service system 106 may determine if the unique number properly maps to the third-party payment account of the sender 102 and whether the use limitations (e.g., one time use or other limits) for the check 110 have been observed or violated. The third-party payment services system 106 also may evaluate the identity of the recipient 104, which may be provided by the sender 102 during the process of initiating the check 110.

If the third-party payment service system 106 determines that one or more use limitations have been violated, the third-party payment service system 106 may deny the payment request. In some embodiments, the third-party payment service system 106 may be arranged to notify the sender 102 when a payment request has been denied or is about to be denied when a use limitation for the check 110 has been violated. By notifying the sender 102 of the violation, the sender 102 is alerted to the fraud attempt or provided with the option of reviewing such violation and instructing the third-party payment service system 106 to accept the payment request. For instance, the sender 102 may have made a mistake which could result in an improper denial or the violation of the use limitation may be a minor infraction that the sender 102 may pardon.

If the third-party payment service system 106 accepts the payment request, the check 110 is verified and settled. The check 110 may be settled, for example, by debiting the third-party payment service system 106 and crediting an account of the recipient 104 for the value of the check 110. The third-party payment service system 106 may debit the third-party payment account of the sender 102 identified by the unique number on the check 110 and/or then withdraw funds for the value of the check 110 from the entity or account of the sender 102 that serves as the source of funds for the check 110 and is linked to the third-party payment account. Upon settlement, the recipient 104 has access to the cash value of the check 110. It can be appreciated that the verification and settlement of the check 110 may be performed by physical delivery and presentment of the check 110, virtual delivery and presentment of the check 110 using electronic funds transfer (EFT) techniques, or any other suitable techniques in accordance with the described embodiments.

Upon completion of the transfer of funds from the sender 102 to the recipient 104, the third party payment service system may record the transaction in the third-party payment account of the sender 102. Thereafter, the third party payment services system 106 may deliver a periodic electronic or paper statement to the sender 102 identifying the completed transfer of funds along with physical delivery of the processed check 110 and/or an electronic image of the processed check 110.

Further aspects and advantages of various embodiments will become more readily appreciated and better understood by the following description of the sender 102, the recipient 104, the third-party payment system 106, as well as other entities illustrated in FIG. 1.

As shown, the sender 102 may comprise or employ one or more client computing devices such as a personal computer (PC) 134 and/or a mobile computing device 136. The sender 102 also may comprise or employ one or more peripheral devices such as a printer 138 and an electronic signature pad 140 including a digitizing pen 142. In various embodiments, the PC 134 and/or the mobile computing device 136 may be used by the sender 102 to access the third-party payment services system 106 and arrange for the payment of goods or services with a printed paper check 110. In some implementations, the printer 138 may be used by the sender 102 to print out the check 110 to be delivered to the recipient 104. In some implementations, the electronic signature pad 140 and digitizing pen 142 may be used by the sender 102 to provide a signature to the third-party payment services system 106 to be printed on the check 110 to be delivered to the recipient 104 by the third-party payment services system 106.

It can be appreciated that while the sender 102 may be depicted in FIG. 1 as including multiple computing devices and peripheral devices, not all devices may be necessary in some implementations. Further, while FIG. 1 may depict exemplary computing devices, the computing device of the sender 102 may comprise or be implemented by various types of computing and/or communications devices such as a desktop PC, notebook PC, laptop computer, smart phone, personal digital assistant (PDA), mobile telephone, combination mobile telephone/PDA, paging device, media device, consumer electronics (CE) device, or any other type of device in accordance with the described embodiments.

The client computing device of the sender 102 generally may comprise or implement various hardware components including, for example, one or more processing devices such as central processing unit (CPU) and/or other processors, memory such as volatile and/or non-volatile memory, a display such as a liquid crystal display (LCD) or cathode ray tube (CRT), input devices such a keyboard, mouse, stylus, touch pad, and/or touch screen, networking devices such as a network interface card (NIC), transceivers and/or antennas in wireless implementations, as well as other components.

The client computing device of the sender 102 generally may be arranged to execute various software programs such as system programs and application programs to provide computing and processing operations in accordance with the described embodiments. Exemplary system programs may include, without limitation, an operating system (e.g., MICROSOFT® OS, UNIX® OS, LINUX® OS, and others), device drivers, programming tools, utility programs, software libraries, application programming interfaces (APIs), and so forth. Exemplary application programs may include, without limitation, a web browser application (e.g., Internet Explorer®, Mozilla®, Firefox®, Safari®, Opera®, Netscape Navigator®), messaging applications (e.g., e-mail, instant messaging, telephone, text messaging), contacts application, calendar application, finance application, word processing application, spreadsheet application, database application, media application, and so forth. Application programs generally may provide one or more graphical user interfaces (GUIs) to communicate information to a user.

In various embodiments, the client computing device of the sender 102 may provide wired and/or wireless communications functionality to support access to the third-party payment services system 106 over one or more types of networks including the Internet 108. In wireless implementations, for example, the client computing device may access the third-party payment service system 106 over the Internet 108 via a WLAN or cellular telephone network such as a Global System for Mobile Communications (GSM) or Universal Mobile Telephone System (UMTS) network that supports WWAN functionality (e.g., GPRS, EDGE, HSDPA, HSUPA, and others).

The third-party payment service system 106 may comprise or implement a plurality of software components embodied as software servers that operate in combination to perform various operations in accordance with the described embodiments. Exemplary servers may include, for example, stand-alone and enterprise-class servers operating server operating systems operating system such as a MICROSOFT® OS, a UNIX® OS, a LINUX® OS, or other suitable operating system. In various embodiments, a plurality of servers may be communicatively coupled with each other via a local area network (LAN) 144 or suitable intranet or back-end network.

In various implementations, the servers of the third-party payment service system 106 may comprise or implement software components that perform distributed operations capable of deployment in an n-tier environment, where one or more servers are used to host server software running in each tier. Under a three-tiered architecture, for example, one more servers and software components may be hosted on a front-end tier, one more servers and software components may be implemented by middleware hosted by an application server or middle tier, and one more servers and software components may be hosted by a back-end tier. It can be appreciated that the servers and software server components may be deployed across a greater number or a fewer number of tiers for a given implementation.

As show in FIG. 1, the third-party payment service system 106 may comprise a communications server 146, a database server 148 and an associated database 150, a payment server 152, a verification server 154, a printing server 156 and associated printing equipment 158, a delivery server 160, and an notification server 162 arranged to communicate and cooperate to perform various operations in accordance with the described embodiments. It can be appreciated that FIG. 1 illustrates an exemplary implementation, and that the functional software components and/or servers may be implemented in various other ways which are consistent with the described embodiments. Furthermore, the operations performed by such software components or servers may be combined and/or separated for a given implementation and may be performed by a greater number or fewer number of software components or servers.

In some embodiments, the communications server 146 may be implemented as a web server arranged to host a plurality of web pages, such as Hypertext Markup Language (HTML) pages, and may include appropriate network interfaces, such as hyper-text transport protocol (HTTP) interfaces, for enabling data to be passed to and received from entities via the Internet 108. The communications server 146 also may be arranged to pass data entered into web pages to other servers within the third-party payment service system 106. The sender 102 may use a web browser running on a computing device to provide an HTTP interface and render web pages in response to web page data (e.g., HTML content) received from the communications server 146. In various embodiments, the communications server 146 may host web pages for enabling the sender 102 to register and/or access a third-party payment account with the third-party payment service system 106 and to initiate and/or complete a transfer of funds to the recipient 104 using a printed paper check 110. The third-party payment account may be linked to a source of funds for the third-party payment account such as entity or account to fund the third-party payment account and the check 110.

It can be appreciated that while some embodiments may be described with the communications server 146 implemented as a web server, the embodiments are not limited in this regard. For example, the communications server 146 may comprise or be implemented as any suitable interface to enable the sender 102 to initiate a transfer of funds or other financial transaction. Exemplary interfaces may include, without limitation, an authenticated/encrypted e-mail interface, a telephone interface such as an IVR system or telephone agent, and/or any other communications interface in accordance with the described embodiments.

The database server 148 may be arranged to maintain and provide access to a database 150 (e.g., relational database, object-oriented database, or other suitable database) containing entries or records for users of the third-party payment service system 106. In various embodiments, the database server 148 may maintain and provide access to a third-party payment account for the sender 102 where information regarding the third-party payment account is stored within the database 150.

The payment server 152 may be arranged to enable payments between buyers and sellers and to post and track financial transactions for users of the third-party payment service system 106. In various embodiments, the payment server 152 may account for a transfer of funds from the sender 102 to the recipient 104 by debiting the account of the sender 102 and/or the source of funds linked to the third-party payment account to effectuate a disbursement of value to the recipient 104 for verified payment requests. It can be appreciated that while certain settlement mechanisms may be described for purposes of illustration, the embodiments are not limited in this regard, and a variety of settlement networks and modalities may be used in accordance with the described embodiments.

The verification server 154 may be arranged to enable secure and/or authenticated transactions for users of the third-party payment service system 106. In various embodiments, the verification server 154 may derive a unique number to be printed on the check 110 to be delivered to the recipient 104. The unique number may be associated or mapped to the user account of the sender 102 and may limit the use of the check 110 as instructed by the sender 102. The verification server 154 may verify a payment request for the check 110 using the unique number printed on the check 110 when use limitations for the check 110 have been observed. The verification server 154 may deny payment requests for checks where use limitations have been violated and/or may provide the sender 102 with the ability to address such violations and authorize payment. It can be appreciated that the unique number may be derived, printed on the check 110, associated with the user account of the sender 102, and/or limit the use of the check 110 in various ways in accordance with the described embodiments.

The verification server 154 also may be arranged to provide details of the check based on the unique number in response to a verification request from the recipient 104 or other entity (e.g., financial institution) seeking to verify and/or request payment for the check 110. In various embodiments, the check 110 may include a unique number as well as a web site and/or a telephone number associated with the third-party payment service system 106 for providing check details and/or verification based on the unique number. In such embodiments, the sender 104 or other entity may access the third-party payment service system 106 using a computing device such as a PC 164, a mobile computing device 166, or other suitable device, provide the unique number in a data field in a web page or in response to voice prompts, and receive check details and/or verification.

The printing server 156 may be arranged receive printing requests and respond using printing equipment 158 to print various items associated with financial transactions for users of the third-party payment service system 106. In various embodiments, the printing server 156 may use the printing equipment 158 to print the check 110 from the sender 102 which is to be delivered to the recipient 104. The check 110 may include a unique number that is associated with the user account of the sender 102 and that limits the use of the check 110 as instructed by the sender 102.

The delivery server 160 may be arranged to provide various mailing or shipping options and to track deliveries for users of the third-party payment service system 106. In various embodiments, the delivery server 160 may coordinate the mailing of the printed check 110 to the recipient 104 and track the delivery of the check 110 when priority or overnight delivery options are selected.

The notification server 162 may be arranged to provide notifications to users of the third-party payment service system 106 or other parties using automated e-mail communications or other types of communication such as telephone, SMS, IM, conventional mail, and others. In various embodiments, the notification server 162 may notify the sender 102 when the check 110 has been printed, mailed, received, presented for payment, resolved, and so forth. The notification server 162 also may provide options to the sender 102 for notifying the recipient 104 of check status. In addition, the notification server 162 may be arranged to notify the sender 102 when a payment request has been denied or is about to be denied for checks where use limitations have been violated so that the sender 102 is alerted to an attempt at fraud and/or can address such violations.

In various implementations, to effectuate a transfer of funds with a paper financial instrument such as the check 110 and ultimately reconcile the transaction, the third-party payment service system 106 may interact with various entities. As shown in FIG. 1, for example, other entities that may be involved with the transfer of funds from the sender 102 to the recipient 104 include a sender bank 168 associated with the sender 102, a recipient bank 170 associated with the recipient 104, and an intermediary bank 172 associated with the recipient bank 170.

It can be appreciated that while an intermediary bank 172 may be illustrated, not all financial transactions may require the use of an intermediary. And, in some cases, the recipient 104 may deposit a check from the sender 102 with the third-party payment service system 106 without using the recipient bank 170 or the intermediary bank 172.

It also can be appreciated that while certain embodiments may be described in the context of a bank, various financial institutions and/or accounts may be used in accordance with the described embodiments. For example, the sender bank 168 may be any entity or account capable of supplying funds to the third-party payment account of the sender 102. Likewise, the recipient bank 170 may be any entity or account capable of providing value to the recipient 104 in exchange for the check 110 of the sender 102. In addition, while the intermediary bank 172 associated with the recipient bank 170 may be a branch of the Federal Reserve Bank, a correspondent bank, or a clearinghouse corporation, the intermediary bank 172 may be any suitable intermediary or entity capable of verifying and/or settling the check 110 from the sender 102 in accordance with the described embodiments.

To use the third-party payment service system 106 to transfer funds with the check 110, the sender 102 accesses a third-party payment account with the third-party payment service system 106. In one embodiment, the sender bank 168 may serve as the source of funds for the third-party payment account and/or the check 110 to be sent from the sender 102 to the recipient 104. Information for the sender bank 168 may be entered to link the sender bank 168 to the third-party payment account and authorize the third-party payment service system 106 to act as an agent for the sender 102 with respect to a particular bank account at the sender bank 168. Accordingly, funds for the check 110 may be transferred from the bank account of the sender 102 at the sender bank 168 to the third-party payment account of the sender 102 via requests made by the third-party payment service 106.

After receiving the check 110, the recipient 104 may deposit the check 110 in the recipient bank 170. Since check clearing typically may be performed internally only for checks drawn on and deposited into the same financial institution, the funds for the value of the check 110 may not be available and convertible to cash by the recipient 104 until the check 110 has undergone verification and settlement.

In the event that the recipient bank 170 and the third-party payment service system 106 have an existing relationship and/or are capable of communicating directly with each other, the recipient bank 170 may present the check 110 to the third-party payment service system 106 along with a payment request. If the third-party payment service system 106 accepts the payment request, the check 110 is verified and settled. The recipient bank 170 may settle the check 110 by debiting the third-party payment service system 106 and crediting the account of the recipient 104 for the value of the check 110. The third-party payment service system 106 may debit the third-party payment account of the sender 102 and/or obtain funds for the value of the check 110 from the sender bank 168. Upon settlement, the recipient 104 has access to the cash value of the check 110.

In cases where the recipient bank 170 and the third-party payment service system 106 do not have an existing relationship and/or are not capable of communicating directly with each other, the recipient bank 170 may pass the check 110 along with a payment request to the intermediary bank 172 for verification and settlement. In some cases, the recipient bank 170 may have an account with a regional branch of the Federal Reserve that handles check collection and check delivery to the Federal Reserve Bank and the paying bank. In some cases, the recipient bank 170 may have a partnership with a correspondent bank in order to exchange checks and payments. In some cases, the recipient bank 170 may be a member of an intermediary bank 172 such as a clearinghouse corporation that allows members to exchange checks and payments in bulk by receiving and exchanging checks drawn on other members.

Upon receiving the check 110 and the payment request from the recipient bank 170, the intermediary bank 172 may identify the third-party payment service system 106 from the routing number 122 of the check 110. The intermediary bank 172 may present the check 110 to the third-party payment service system 106 along with a payment request. If the third-party payment service system 106 accepts the payment request from the intermediary bank 172, the check 110 is verified and settled.

The intermediary bank 172 may settle the check 110 by debiting the third-party payment service system 106 and crediting the recipient bank 170 for the value of the check 110. The third-party payment service system 106 may debit the third-party payment account of the sender 102 and/or obtain funds for the value of the check 110 from the sender bank 168. The recipient bank 170 may credit the account of the recipient 104 for the value of the check 110. Upon settlement, the recipient 104 has access to the cash value of the check 110.

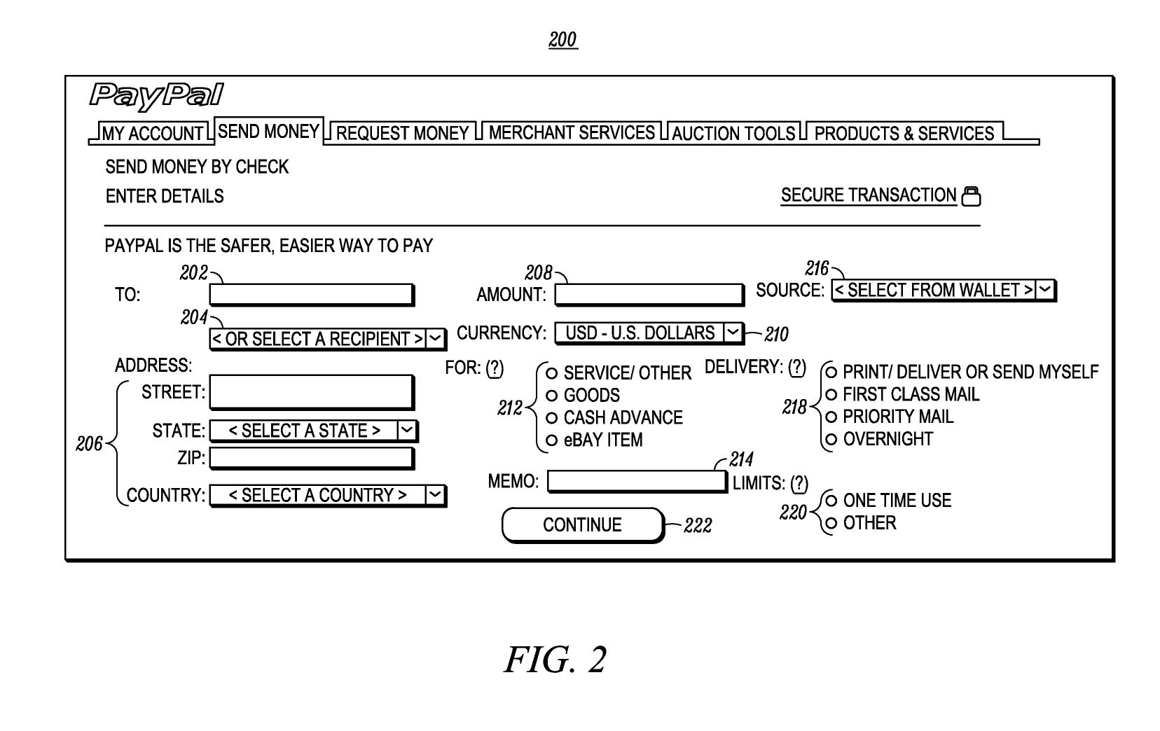

FIG. 2 illustrates one embodiment of a web page 200 which may be hosted by the third-party payment service system 106 for providing third-party payment services in accordance with various embodiments. In various implementations, the sender 102 may navigate to the web page 200 associated with the third-party payment service system 106 and enter details for the check 110 to initiate a transfer of funds to the recipient 104.

As shown, the web page 200 comprises a name field 202 for entering the name of a recipient or payee, a contacts pull-down menu 204 for selecting a recipient, and address fields 206 for entering the address of a recipient and/or delivery information. In some cases, when a recipient is selected from the contacts pull-down menu 204, the address of the recipient as well as other check details may be populated automatically. In some cases, various check details may be populated automatically based on previous transaction history when a certain recipient 104 is entered or selected.

The web page 200 also comprises a value amount field 208 and a currency pull-down menu 210 for entering the amount of the check. The web page 200 comprises predefined category buttons 212 and a memo field 214 for identifying the purpose of the check. The web page 200 also comprises a source of funds pull-down menu 216 associated with an electronic wallet of the sender for allowing the sender to select among various funding sources.

The web page 200 comprises delivery option buttons 218 for coordinating the delivery of the check to the recipient. The web page also comprises use limits buttons 220 for limiting the use of the check to one time use or in various other ways. After entering the check details into the web page 200, the continue button 222 may be selected to navigate to another web page or commence various other operations such as automatically populating various check details, deriving a unique number to be printed on the check, designating other use limitations, and/or printing the check including the unique number.

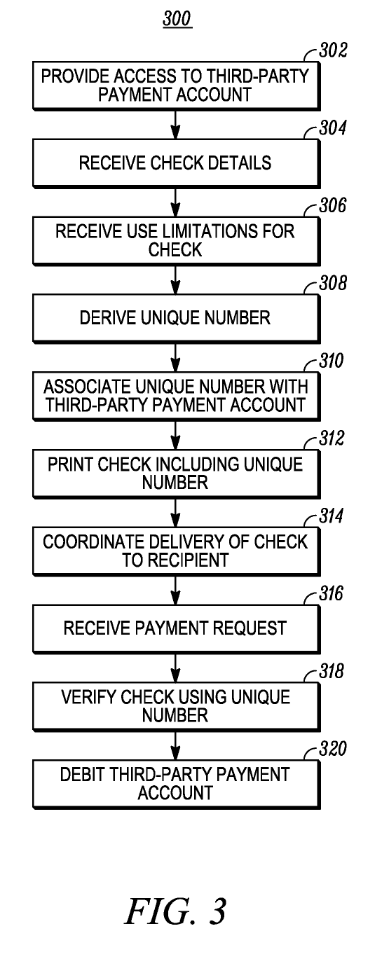

FIG. 3 illustrates a logic flow 300 in accordance with various embodiments. The logic flow 300 may be performed by various systems and/or devices and may be implemented as hardware, software, firmware, and/or any combination thereof, as desired for a given set of design parameters or performance constraints. For example, the logic flow 300 may be implemented by a logic device (e.g., computing device, server, and/or processor) and/or logic (e.g., computer executable program instructions) to be executed by a logic device. For purposes of illustration, and not limitations, reference may be made to the foregoing reference numerals and Figures.

The logic flow 300 may comprise providing access to a third-party payment account (block 302), receiving check details (block 304), and receiving use limitations for a check (block 306). In various embodiments, the third-party payment services system 106 may provide access to a sender 102 for transferring funds from a third-party payment account to a recipient using a printed paper check 110. The third-party payment account may be hosted by the third-party payment server system 106 and linked to a source of funds for the third-party payment account such as entity or account to fund the third-party payment account and the check 110.

The third-party payment services system 106 may receive certain check details from the sender 102 and may automatically provide certain check details. In some cases, the third-party payment services system 106 may automatically provide certain check details in response to details provided by the sender 102 and/or based on previous transaction history. In some implementations, the check details may comprise a source of the funds for the check 110 selected by the sender 102 from an electronic wallet. The third-party payment services system 106 may receive limitations on the use of the check 110 such as limiting the check 110 to one time use, limiting use to a certain recipient, limiting use to a certain number of transactions, limiting use to certain values, and/or limiting use to certain dates.

The logic flow 300 may comprise deriving a unique number (block 308), associating the unique number with a third-party payment account (block 310) and printing the check including the unique number (block 312). In various embodiments, the third-party payment service system 106 may derive a unique number and associate the unique number with the third-party payment account of the sender 102. In some implementations, the check 110 may include a unique number that is capable of being verified based on the use limitations of the check. In some cases, unique numbers may be reused after a certain significant time period has elapsed. In some cases, certain ranges of unique numbers may be used to facilitate back-end processing and/or tracking.

When associated with the third-party payment account of the sender 102, the unique number may be used by the third-party payment service system 106 to differentiate among transaction and users, identify the third-party account of the sender 102, access various details of the check 110, verify the check 110, and/or identify and withdraw funds from entity or account of the sender 102 that serves as the source of funds for the check 110 and that is linked to the third-party payment account. While the unique number may reference the third-party payment account of the sender 102, there is no direct relationship or correlation between the unique number and the entity or account of the sender 102 which is used to fund the third-party payment account and the check 110.

After the unique number is derived and associated with the third-party payment account of the sender 102, the check 110 may be printed using the local printing capabilities of the sender 102 or the printing capabilities of the third-party payment services system 106. The check 110 may be printed to include the unique number derived by the third-party payment service system 106 as well as various check details which were entered by the sender 102 and/or are automatically populated by the third-party payment service system 106.

The check 110 may comprise a routing number 122, an account number 124, and a check number 126. The routing number 122 may be associated with and used to identify an entity capable of handling a payment request and/or verification of the check 110 such as the third-party payment services provider 106 and/or a financial entity having a contractual relationship with the third-party payment services provider 106. The check 110 also may comprise contact information 130 for directing inquiries regarding check details and/or verification based on the unique number.

In some implementations, the unique number may be printed as the account number 124. In some implementations, the unique number may be printed as the check number 126. When the check number 126 comprises the unique number, the account number 124 on the check 110 may be associated with a single master account at the third-party payment service system 106.

The logic flow 300 may comprise coordinating the delivery the check to a recipient (block 314), receiving a payment request (block 316), verifying a payment request for the check using the unique number (318), and debiting the third-party payment account (block 320). In various embodiments, the third-party payment services system 106 may coordinate delivery to the recipient according to the check details entered by the sender. After the check 110 is delivered to the recipient 104, a payment request for the check 110 may be received by the third-party payment services system 106. Upon receiving a payment request for the check 110, the third-party payment services system 106 may verify the payment request for the check 110 using the unique number printed on the check 110 by identifying the third-party payment account of the sender 102, accessing various details of the check 110, and determining whether the use limitations for the check 110 have been observed or violated.

If one or more use limitations have been violated, the third-party payment service system 106 may deny the payment request or notify the sender 102 that a payment request has been denied or is about to be denied. By notifying the sender 102 of the violation, the sender 102 is alerted to the fraud attempt or provided with the option of reviewing such violation and instructing the third-party payment service system 106 to accept the payment request. If the third-party payment service system 106 accepts the payment request, the check 110 is verified and settled by debiting the third-party payment account of the sender 102 identified by the unique number on the check 110 and/or withdrawing funds for the value of the check 110 from the entity or account of the sender 102 that serves as the source of funds for the check 110 and is linked to the third-party payment account. Upon settlement, the recipient 104 has access to the cash value of the check 110. It can be appreciated that the logic flow 300 may include various other steps in accordance with the described embodiments.

In various embodiments, one or more operations of the logic flow 300 may comprise, or be implemented as, executable computer program instructions. The executable computer program instructions may be implemented by software, a software module, an application, a program, a subroutine, instructions, an instruction set, computing code, words, values, symbols or combination thereof. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The executable computer program instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

In various embodiments, one or more operations of the logic flow 300 may comprise, or be implemented as, executable computer program instructions stored in an article of manufacture and/or computer-readable storage medium. The article and/or computer-readable storage medium may store executable computer program instructions that, when executed by a computer, cause the computer to perform methods and/or operations in accordance with the described embodiments. The article and/or computer-readable storage medium may be implemented by various systems and/or devices in accordance with the described embodiments.

The article and/or computer-readable storage medium may comprise one or more types of computer-readable storage media capable of storing data, including volatile memory or, non-volatile memory, removable or non-removable memory, erasable or non-erasable memory, writeable or re-writeable memory, and so forth. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other suitable type of computer-readable media in accordance with the described embodiments.

Although some embodiments may be illustrated and described as comprising exemplary functional components or modules performing various operations, it can be appreciated that such components or modules may be implemented by one or more hardware components, software components, firmware components, and/or combination thereof.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, or any combination thereof.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, API, exchanging messages, and so forth.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A system comprising:
a database server to provide access to a third-party payment account linked to a source of funds for the third-party payment account;
a communications server to receive a request to transfer funds from the third-party payment account to a recipient using a printed check and to receive a use limitation for the check; and
a verification server to derive a unique number to be associated with the third-party payment account and printed on the check and to verify a payment request for the check using the unique number when use limitations for the check have been observed.

2. The system of claim 1, further comprising:
a payment server to debit one or more of the third-party payment account and the source of funds for the third-party payment account.

3. The system of claim 1, further comprising a printing server to print the check.

4. The system of claim 1, the use limitation comprising one or more of one time use of the check, limiting use to a certain recipient, limiting use to a certain number of transactions, limiting use to certain values, and limiting use to certain dates.

5. The system of claim 1, the check to be printed with an account number comprising the unique number based on the use limitation.

6. The system of claim 1, the check to be printed with a check number comprising the unique number and an account number comprising a master account of the third-party payment services system.

7. The system of claim 1, the check to be printed with a routing number associated with at least one of the third-party payment services system and a financial entity having a contractual relationship with the third-party payment services system.

8. A method comprising:
providing access to a third-party payment account hosted by a third-party payment server system and linked to a source of funds for the third-party payment account;
receiving a request, via a communications interface hosted by the third-party payment server system, to transfer funds from the third-party payment account to a recipient using a printed check;
receiving a use limitation for the check;
deriving a unique number to be associated with the third-party payment account and to be printed on the check; and
verifying a payment request for the check using the unique number when use limitations for the check have been observed.

9. The method of claim 8 further comprising debiting one or more of the third-party payment account and the source of funds for the third-party payment account.

10. The method of claim 8, the use limitation comprising one or more of one time use of the check, limiting use to a certain recipient, limiting use to a certain number of transactions, limiting use to certain values, and limiting use to certain dates.

11. The method of claim 8, the check to be printed with an account number comprising the unique number based on the use limitation.

12. The method of claim 8, the check to be printed with a check number comprising the unique number and an account number comprising a master account of the third-party payment services system.

13. The method of claim 8, the check to be printed with a routing number associated with at least one of the third-party payment services system and a financial entity having a contractual relationship with the third-party payment services system.

14. A computer-readable storage medium comprising executable computer program instructions that if executed enable a computing system to:
provide access to a third-party payment account linked to a source of funds for the third-party payment account;
receive a request to transfer funds from the third-party payment account to a recipient using a printed check;
receive a use limitation for the check;
derive a unique number to be associated with the third-party payment account and to be printed on the check; and
verify a payment request for the check using the unique number when use limitations for the check have been observed.

15. The computer-readable storage medium of claim 14, further comprising executable computer program instructions that if executed enable a computing system to debit one or more of the third-party payment account and the source of funds for the third-party payment account.

16. The computer-readable storage medium of claim 14, further comprising executable computer program instructions that if executed enable a computing system to print the check and to coordinate delivery of the check to the recipient.

17. The computer-readable storage medium of claim 14, the use limitation comprising one or more of one time use of the check, limiting use to a certain recipient, limiting use to a certain number of transactions, limiting use to certain values, and limiting use to certain dates.

18. The computer-readable storage medium of claim 14, further comprising executable computer program instructions that if executed enable a computing system to print the check with an account number comprising the unique number based on the use limitation.

19. The computer-readable storage medium of claim 14, further comprising executable computer program instructions that if executed enable a computing system to print the check with a check number comprising the unique number and an account number comprising a master account of the third-party payment services system.

20. The computer-readable storage medium of claim 14, further comprising executable computer program instructions that if executed enable a computing system to print the check with a routing number associated with at least one of the third-party payment services system and a financial entity having a contractual relationship with the third-party payment services system.
